(19) United States
(12) Patent Application Publication
(10) Pub. No.: US 2004/0266418 A1
(43) Pub. Date: Dec. 30, 2004

(54) Method and apparatus for controlling an electronic device

(75) Inventor: Michael D. Kotzin, Buffalo Grove, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/608,593

(22) Filed: Jun. 27, 2003

(51) Int. Cl. H04M 3/00; H04B 1/38

(52) U.S. Cl. 455/420; 455/563

(57) ABSTRACT

A method (300, 400), system (245) for and corresponding communications unit 200 provide assistance for and control of the unit. The system in one embodiment, preferably comprises: a processor (223) and a memory (225); where the processor interprets a control message, available from a local application or remote agent (119), that corresponds to one or more control commands, such as keypad activations to provide keypad data and executes software instructions stored in the memory to control the communication unit according to the keypad data. The control message can represent voiced instructions that have been converted to control commands in order to provide assistance to a user of the unit or device.

### RELATED APPLICATIONS

The present application is related to co-pending applications designated with docket numbers CS22156RL/10-160 and CS22157RL/10-161 by Kotzin having a like filing date and the same assignee. CS22156RL/10-160 is titled METHOD AND APPARATUS FOR PROVIDING ASSISTANCE TO A COMMUNICATIONS UNIT OVER A NETWORK. CS22157RL/10-161 is titled METHOD AND APPARATUS FOR PROVIDING SECURE ASSISTANCE TO A COMMUNICATIONS UNIT OVER A NETWORK. Each of these applications is hereby incorporated in this application by reference.

### FIELD OF THE INVENTION

This invention relates in general to electronic devices such as communications units, and more specifically to a method and apparatus for controlling such devices.

### BACKGROUND OF THE INVENTION

Electronic devices such as communications units or subscriber devices providing data and voice services for users operating in corresponding systems are known. Operating these devices or units by interacting with a keypad or keyboard and display can be challenging when the user is otherwise preoccupied. It is known to include voice recognition systems to assist with controlling these devices for some purposes, however voice recognition systems are often marginal, suffer in high ambient noise environments, and can be a burden if the recognition system needs to be trained.

Controlling electronic devices or communications units from applications, for example, has been contemplated but such control has been limited to APIs (application program interfaces) where the interface details are defined according to the API. It is known to download software including applications to communication units as well as to configure the units. With these approaches there is a security risk and thus only highly trusted sources can have access to the unit. Clearly a need exists for methods and apparatus to control an electronic device and thereby render assistance as required to the device.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages in accordance with the present invention.

FIG. 1 depicts, in a simplified and representative form, a communications system and electronic devices or communications units suitable for implementing methods of controlling and assisting the devices or units;

FIG. 2 depicts a block diagram of a preferred embodiment of a communications unit that is arranged to be controlled or assisted with control;

FIG. 3 depicts a flow chart of one embodiment of a method of providing assistance to an electronic device; and

FIG. 4 shows a flow chart of a further method of controlling an electronic device, such as a communications unit.

### DETAILED DESCRIPTION OF PREFERRED EMBODIMENTS

In overview, the present disclosure concerns electronic devices such as communications units and methods and apparatus for controlling and providing assistance with controlling such devices or communications units. This control or assistance may be provided from local or internal applications or via communications systems that provide or facilitate services such as voice and data communications services to wired or wireless devices or communications units. The wireless communications units are often referred to as subscriber devices, such as cellular phones or two-way radios or messaging devices and the like operating therein. More particularly various inventive concepts and principles embodied in systems, electronic devices or communications units, and methods therein for providing, initiating, or facilitating control or assistance of the device or unit are discussed and described. Note that the devices or units can be a variety of devices, such as a personal digital assistant, personal assignment pads, and personal computers equipped for wireless operation, a cellular handset or device, or equivalents thereof provided such units are arranged and constructed for operation in accordance with the principles and concepts described and discussed.

The principles and concepts discussed and described may be particularly applicable to devices and systems and communications units that can provide or facilitate voice communications services or data or messaging services over wide area networks (WANs), such as conventional two way systems and devices, various cellular phone systems including analog and digital cellular, CDMA (code division multiple access) and variants thereof, GSM (Global System for Mobile communications), GPRS (General Packet Radio System), 2.5 G and 3G systems such as UMTS (Universal Mobile Telecommunication Service) systems, integrated digital enhanced networks and variants or evolutions thereof. Furthermore the wireless communications units or devices can have short range communications capability normally referred to as W-LAN capabilities, such as IEEE 802.11, Bluetooth, or Hiper-LAN and the like that preferably utilize CDMA, frequency hopping, orthogonal frequency division multiplexing, or TDMA access technologies and one or more of various networking protocols, such as TCP/IP (Transmission Control Protocol/Internet Protocol), IPX/SPX (Inter-Packet Exchange/Sequential Packet Exchange), Net BIOS (Network Basic Input Output System) or other protocol structures.

As further discussed below various inventive principles and combinations thereof are advantageously employed to initiate a request for assistance with a voice message that is converted to control commands with the commands being used to effect control of the device or unit. Control of the device or unit may be implemented by sending the controlling entity for the unit a message corresponding to normal keypad data. This controlling approach can be used for applications beyond providing assistance to the unit and advantageously allows a greater degree of protection for misuse of the device than typical application program interface control. In this manner a remote agent can advantageously be tasked with converting voiced commands to control commands, such as keypad data, to assist with those activities that may detract from other duties, such as driving a vehicle or control of a device or unit can be effected with minimal risk of misuse or abuse, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

Referring to FIG. 1, a simplified and representative diagram of a communications system and electronic devices or communications units suitable for implementing methods of controlling and assisting the devices or units will be discussed and described. FIG. 1 shows wireless communications units 101, 103, 105 or communications or electronic devices. These units include a cellular handset 101 coupled via radio signals to a wide area radio access network 109 (radio WAN 109), such as a mobile phone or cellular system. Further included or depicted is a personal computer, such as a laptop or tablet computer that is shown coupled via radio signals to a W-LAN access network or access point 113 and further to LAN 115 (W-LAN 115). The W-LAN 115 is preferably based on IEEE 802.11 with corresponding access points but may also be a Bluetooth or other short range wireless LAN. Additionally a personal digital assistant or the like is depicted as coupled, via for example a wired LAN or, to an ISP 117 (Internet Service Provider).

The radio access network or radio WAN 109, LAN 115, and ISP 117 are coupled to a WAN, such as the Internet or World Wide Web or the like. In this manner each of the devices or communications units 101, 103, 105 are able to contact and be coupled to various servers, including an entity designated remote agent 119. These networks can serve a multiplicity of devices or units. Generally the radio access networks, W-LAN, and WAN systems are known to one of ordinary skill and will not be further described in any detail, apart from the necessities with respect to the preferred embodiments. The communications units 101, 103, 105 are also generally known other than the modifications and improvements disclosed herein. Thus the known functions and structure of such devices will not be described in detail other than as related to the inventive principles and concepts disclosed and discussed below. Note also that any one of the devices or units discussed above may have access to more than one network, for example the radio access network and W-LAN network.

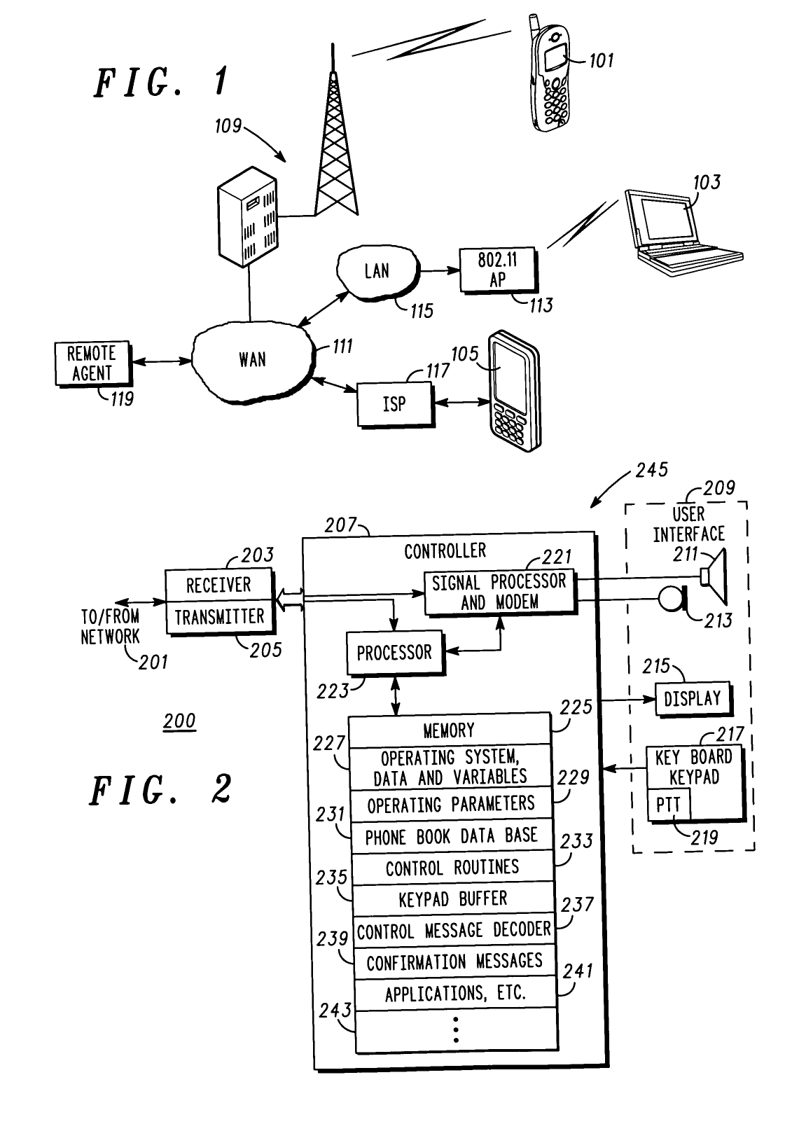

Referring to FIG. 2 a block diagram of a preferred embodiment of an electronic device or communications unit 200, similar to one of the devices 101, 103, 105, that is arranged to be controlled or assisted with control will be discussed and described. The communications unit is arranged and constructed for utilizing remote assistance from or being controlled by an agent, such as a remote agent. Note that the specific functionality of portions, functional blocks or elements of the communications unit or device will depend on the particular access technology and other conventions used by the network providers. These specifics of transmission and reception and relevant processing are known and therefore any further discussions will be in generalities that are applicable to typical communications systems.

The communications unit or device is coupled to and from a network 201 via an antenna for wireless networks or normal wired connections such as an RJ 45 connector. Signals from the network are coupled to and received by a receiver 203 or transmitted or sent from a transmitter 205 to the network as is known. The receiver 203 and transmitter 205 may be operational in a radio WAN network, such as conventional cellular or two way wireless networks or in a short range W-LAN type of network suitable for effecting an 802.11 CDMA connection or Bluetooth frequency hopping spread spectrum connection or the like or in a typical wired network such as an Ethernet environment or some combination of multiple such WAN, LAN, and W-LAN interfaces or air interface connections. The receiver 203 provides a signal that is coupled to a controller 207 for further processing, such as call and audio or message processing. The transmitter 205 is also coupled to the controller 207 and the controller 207 operates to generate messages and so on, as known, to prepare uplink signals for amplification and transmission by the transmitter 205.

The controller 207 is coupled to a user interface 209 that includes, for example, audio transducers, such as an earpiece or speaker 211 and microphone 213, display 215, keypad 217, and a PTT or PTA key 219 specifically depicted. The transmitter 205, receiver 203, and user interface 209 are each inter-coupled, as depicted, to the controller 207 and the controller 207 provides overall operational command and control for the communications unit. The controller 207 is coupled to and operates together with the audio transducers, display and keyboard or set of keys to effect a portion of a user interface experience that may depend on the particular device and its features and to facilitate generation and consumption of messages or other information. The audio transducers are known and commonly available. The keyboard can be a known physical keyboard or virtual keyboard that is part of the display and the display is also known and can be a liquid crystal display or the like. When the keys are part of a virtual keyboard the display will be composed of touch sensitive material or the like in order to convey information to the controller 207.

The controller 207 includes a signal processor/modem 221, typically digital signal processor based that is used for generating signals to be provided to the transmitter as well as processing signals from the receiver. The signal processor 221 functionally includes known and appropriate A/D and D/A convertors, an audio vocoder, channel coders and decoders, a modem, and other known functions, some of which are dependent upon the access technology employed by the communication unit. For example audio from the microphone 213 is processed through an A/D convertor and then the vocoder to provide audio frames. These frames may be combined or sequenced with other control information, data, and the like, channel coded, packetized (consistent with known VoIP schemes) and then used to modulate, via the modem, a signal that may be the carrier signal or a signal that is subsequently up converted to the carrier frequency signal and amplified by the transmitter. The signal processor also works essentially in reverse to demodulate signals from the receiver and provide messages or data for further processing by the controller, including for example applying voice packets to a vocoder with an output coupled to a D/A convertor that is used to drive the earpiece or speaker 211. The controller further includes a processor 223 that is, preferably, a known microprocessor based element that is widely available and can include one or more microprocessors and one or more digital signal processors depending on the precise responsibilities of the controller 207 with respect to signaling duties and call processing that are not here relevant. The processor 223 can be coupled to a port not shown that allows an external device, such as a portable computer or the like to interface to the communications device and thus become, for example, a part of the user interface 209 or a diagnostic and testing apparatus.

In any event the processor 223 is also coupled to a memory 225 that can be, for example, a combination of known RAM (Random Access Memory), ROM (Read-Only Memory), EEPROM (Electrically Erasable Programmable ROM) or magnetic memory that among other items, such as messages and folders with messages, address books, standard or canned messages, and various operating variables and parameters will store an operating system or software and various operating variables and parameters 227 for execution and use by the processor 223. This operating software when executed by the processor 223 will result in the processor 223 performing the requisite functions of the communications device or unit such as interfacing with and controlling the transceiver or transmitter 205, receiver 203, signal processor/modem 221 and user interface 209 including display and keyboard, audio processing functions and so on including other functional elements not depicted and software routines that will be further described below.

The memory 225 further includes call processing routines not specifically shown for supporting voice and data calls that will be appreciated by one of ordinary skill and that will vary depending on air interface, call processing, and service provider or network specifics. As depicted, the memory 225 further includes space for one or more operating parameters 229, such as frequencies, other air interface specifics, unit access and feature parameters, ringer types and ringer and audio volumes. Further included in the memory are databases 231, such as one or more of a phone book, address book and the like, control routines 233 (can be part of operating system depending on software architecture) corresponding to the various features and functions of the unit or device, such as dialing or looking up a number, etc., and a keypad buffer 235 for storing keypad data typically on a first in first out basis.

Also included and further discussed below are control message decoding routines 237, confirmation messages routines 239, and applications 241, such as accounting and spreadsheet applications, browsers, games, audio players and the like. The reader or one of ordinary skill will appreciate that this listing is merely a brief listing of exemplary routines that will be required or advantageous in effecting a communications device or unit for controlled services and various command and control duties and that many others 243 including user interface drivers, call processing routines, etc. that can be stored in the memory have not been mentioned.

The following discussion will focus on the operational interactions and refer to the FIG. 2 depiction of a communications device or unit 200 that can be controlled in an advantageous manner and thereby utilize a form of remote assistance. The communications unit 200, as noted above, is arranged and constructed for reasonably secure control of the unit and this capability may be used for taking advantage of remote assistance service when desired. The communications unit 200 includes the transmitter 205 that is used to send a message corresponding to voiced instructions to a remote agent, such as the remote agent 119 where this remote agent can be a person at a console or could be an automated system with exceptionally capable voice recognition equipment and some artificial intelligence or some combination of both. In one embodiment this message is sent or transmitted using known VoIP (voice over Internet protocol) techniques, such as available in TDMA, GSM, GPRS, 2.5G, EDGE, WCDMA, 3G, UMTS, and versions of 802.11 LAN systems or other systems and protocols that utilize or support VoIP. Which network the transmitter is connected to will determine which network is used for sending this message. Furthermore, the message will include an address or identifier, such as a URI (uniform resource identifier) that may be used by the remote agent for purposes of uniquely identifying the communications unit that is sending the message.

The communications unit 200 also includes the receiver 203 that is used to receive, responsive to the message from the transmitter, a control message from the remote agent. Preferably, the receiver receives the control message over a known packet data connection, such as those available in TDMA, GSM, GPRS, 2.5G, EDGE, WCDMA, 3G, UMTS, and versions of 802.11 LAN systems or other systems and protocols that utilize or support packet data including VoIP. Note that it is possible that the message and control message are exchanged over a network other than the network that primarily provides services to the communications unit. A cross reference between the unit's URI or other identifier can be used by the remote agent to insure that the control message is compatible with the particular communications units control structure and architecture.

In any event the communications unit 200 also includes the controller 207 that is coupled to the transmitter and the receiver and used to decode the control message using decoding routines 233 to obtain and execute control commands via the control routines 233 that correspond to a conversion of the voiced instructions by the remote agent. The control commands can be typical java based API commands or another agreed upon command set that is understood by the communications unit or as will be further discussed below, the control commands can be keypad data identical to what would be generated with a local keypad activation. The cross reference between the unit's URI or other identifier as suggested above can be used by the remote agent to insure that the control commands in the corresponding control message are compatible with the particular communications units control conventions.

The communications unit uses the user interface 209 for providing the voiced instructions; specifically microphone 213 is coupled to the signal processor and modem 221. In a preferred embodiment a predetermined keypad sequence or key pad activation such as the push-to-talk button 219 or a push to assist button or the like is used to initiate sending the message e.g. capturing the voiced instructions from the user, setting up an appropriate link to the remote agent, and sending the message. In one embodiment the receiver 203 will receive a confirmation message from the remote agent when the message has been received and the controller will provide on the user interface an indication of the confirmation message, such as a happy beep via the speaker or a message on the display using the confirmation messages routines 239. This confirmation message may be helpful to a user, for example, when there is a delay at the remote agent in providing the control message.

Similarly the controller can provide an indication on the user interface when the actual control message has been received, thereby providing some degree of warning to the user that the device or unit will begin or is executing his desired actions as reflected in the voiced instructions. This indication can be even more user friendly if it is audible. For example the unit can include software applications to convert control commands or keypad presses to speech similar to text to speech conversion software. Preferably some interpretation would be available so a relatively long list of keypad presses might be verbalized to the user as “JOHN DOE is being added to location xyz in your phone book”. The verbalized indication to the user can also be provided by the remote agent, via VoIP messages or packets, together with the command controls or sequence.

Note also that the remote agent may require the user of the communications unit to repeat the voiced instructions if they are not initially understood. Also it can be appropriate to have the controller, prior to executing a portion of the control commands, request an approval or confirmation from a user via the user interface and this can be part of the confirmation routines 239. The request can be a distinctive audible signal with the approval being another activation of the PTT or PTA (push to assist) or other appropriate button. This approval request can also be verbalized using one of the approaches noted above. For example if the user had requested that John Doe be called, the verbalized indication to the user might be “John Doe may be called by pressing SND”. Defining the portion of the control commands that require a confirmation or approval from the user will best be determined by the purveyor of the communications unit, but control commands corresponding to such things as dialing some numbers (overseas, or 900) or erasing a portion of a phone book may be likely candidates.

Using the above principles and concepts, the communications unit or specifically controller by executing the control commands can result in a change in an operation, a parameter setting 229, or a database 231 within or associated with the communications unit. For example by executing the control commands the communications unit can be caused to or result in dialing a number, looking up a number in a phone book associated with the communications unit and dialing the number, or sending a text message. One preferred approach is where the control message corresponds to one or more keypad activations and the controller decodes the control message to obtain keypad data corresponding to the one or more keypad activations, stores the keypad data in keypad buffer 235 and executes commands according to the keypad data. Thus the voiced instructions, for example, can be a request for modifying contents of a memory or phone book, dialing a number, looking up a number, and sending a text message, and the control message responsive thereto will correspond to keypad activations for, respectively modifying the contents of the memory, dialing the number, looking up the number, and sending the text message according to the voiced instructions.

A user of the communications unit or device, as above described, may find the current challenge of operating an automobile or walking a crowded street while dialing a 10 or more digit phone number reduced to activating a PTT or PTA and providing voiced instructions, such as call 987 123 4567 or call Mom and receiving a friendly beep when the call is being dialed by the unit. In the “call Mom” example the remote agent would need access to the unit's phone book by way of queries and response messages or access to a mirrored and synchronized phone book. The mind numbing task of sending a message to Jim Jones using for example a phone's normally numeric keypad, such as “please delay our 3PM meeting for 10-15 minutes” is again reduced to activating a button, speaking the instructions and waiting for a happy beep when the communications unit is sending the text message via for example SMS (short message service). Storing a phone number for work with an associated name at a particular location in a phone book is again straightforward for the user.

A portion of the communications unit is a system 245 for controlling the communications unit. The system 245 can be integral to the communications unit as depicted or an add on or accessory system with appropriate coupling between an ordinary controller for a communications unit and the system 245. Much of the functionality and operation of the system 245 has been described above so the description provided here will be in the nature of a summary and overview. The system 245 comprises a controller further comprising a processor and a memory; where the processor operates to interpret or decode a control message that corresponds to one or more keypad activations to provide keypad data; and a keypad buffer for storing the keypad data. The processor then executes software instructions stored in the memory to control the communication unit according to the keypad data.

The system 245 can obtain or acquire the control message from, for example, an application 241 internal to the communications unit or a remote control agent or remote application. It may be preferable for the processor to execute the software instructions to control the communications unit according to the keypad data after requesting and obtaining a confirmation from a user of the unit similar to the approach descried above and this requesting the confirmation from the user preferably depends on the particulars of the keypad data. The processor executing the software instructions will result in a change in an operation, a parameter setting, or a database within the communications unit, such changes resulting in, for example, dialing a number, looking up a number in a phone book associated with the communications unit, or sending a text message.

The system 245 can also be a system (system 245) that is arranged, constructed, and disposed within a communications unit and that is suitable for utilizing remote assistance to control the communication unit. Much of the functionality and operation of the system for utilizing remote assistance to control the communication unit has been described above so the description provided here is in the nature of a summary and overview. The system 245 is hereby defined to comprise a user interface 209 for providing a voiced signal corresponding to voiced instructions; and a controller 207, coupled to the user interface and further comprising: a modem 221 for generating a message corresponding to the voiced signal, the message intended for a remote agent and for demodulating a control message provided, responsive to the message, by the remote agent; and a processor 223, coupled to the modem, to decode the control message to obtain and execute control commands that correspond to a conversion of the voiced instructions by the remote agent.

Preferably the user interface further comprises a PTT or PTA button to initiate generating the message upon activation of the button. The remote agent in one embodiment provides and the modem demodulates a confirmation message when the message with the voiced instructions has been received. Preferably, the processor provides an indication of the confirmation message as well as the control message when received on the user interface as discussed above. Furthermore the controller, prior to executing a portion of the control commands, can request an approval from a user via the user interface.

These control commands when executed by the processor result in a change in one or more of an operation, a parameter setting, or a database within the communications unit, where these changes include or result in, for example, one or more of dialing a number, looking up and dialing a number in a phone book associated with the communications unit, and sending a text message. In one embodiment the control message, provided by the remote agent, corresponds to a or a string of keypad activations and the processor decodes the control message to obtain keypad data corresponding to the keypad activations, stores, preferably, the keypad data in the keypad buffer, and executes commands according to the keypad data from the buffer.

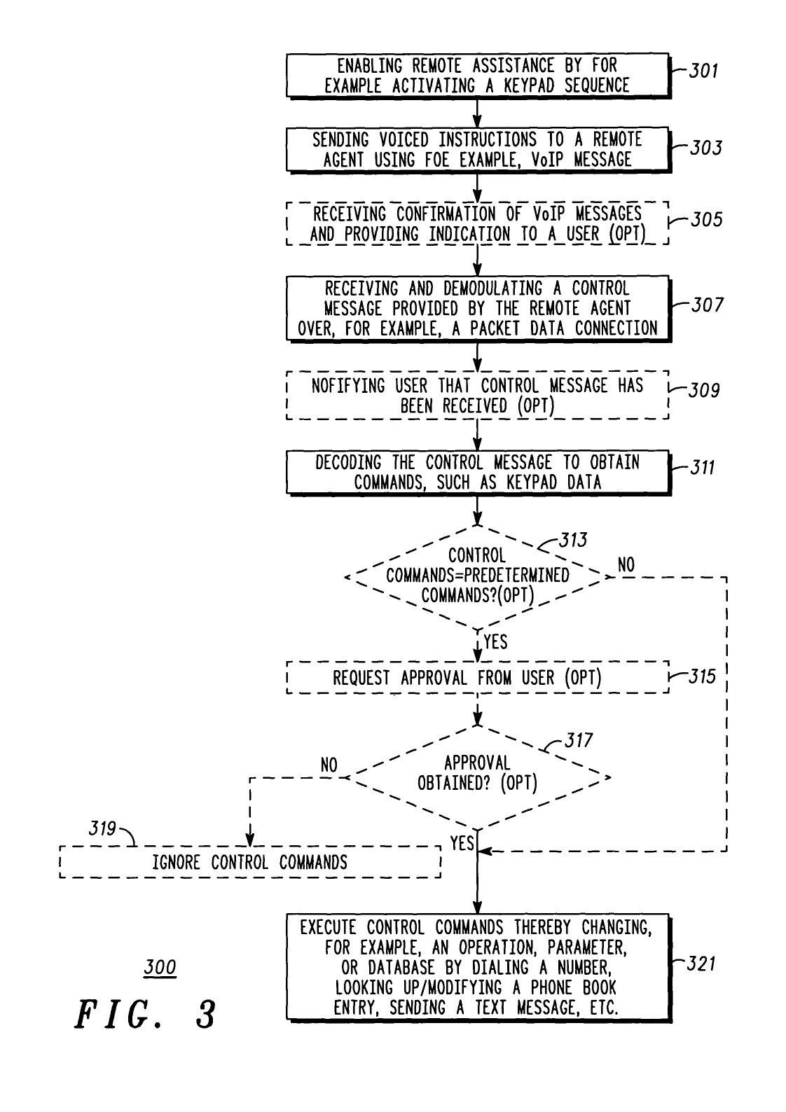

Referring to FIG. 3, a flow chart of a preferred method 300 of one embodiment of a method of providing assistance and controlling an electronic device or communications unit will be reviewed and discussed. Some of this discussion will be in the nature of a review and summary of portions of the discussions above. The device or unit 200 of FIG. 2 can advantageously perform the method 300 although various other structures would also be suitable for performing the method 300. The method 300 begins at 301 where remote assistance is enabled by for example activating a keypad sequence, such as pressing a PTT or PTA button. Next at 303 voiced instructions are sent to a remote agent using for example one or more messages or packets formatted in a known VoIP (voice over IP) manner. Optional process 305 indicates receiving a confirmation message confirming the VoIP messages and providing an indication of this confirmation message to a user.

Then 307 shows receiving and demodulating a control message that has been provided, for example by the remote agent over, for example, a packet data connection. The control message corresponds to control commands suitable or compatible with and for controlling the unit or device that sent the voiced instructions, such as keypad activations. Optional process 309 indicates notifying the user that the control message has been received. Thereafter 311, shows decoding or converting the control message in order to obtain or provide control commands, such as keypad data corresponding to the keypad activations.

After 311 a series of optional processes determine whether the control commands are equivalent to a set of predetermined commands 313 and if so a request for approval from the user is issued at 315. If the approval or confirmation that the control commands should be executed is not obtained as tested at 317 the control commands are ignored at 319 with a user notification when desired. If the approval is obtained at 317 or if the control commands do not require approval (not equal to predetermined commands) at 313, the process at 321 is performed. This process includes executing the control commands, thereby changing for example, an operation, parameter, or database by dialing a number, looking up or modifying a phone book entry, sending a text message, and the like.

The method 300 can thus be used for sending voiced instructions to a remote agent where the control message that is received is from the remote agent and is responsive to the sending the voiced instructions. The control message will correspond to one or more keypad activations that correspond to a conversion of the voiced instructions by the remote agent. For example, the voiced instructions can be a request to modify contents of a memory of the electronic device and the control message will correspond to control commands, such as keypad activations for modifying the contents according to the voiced instructions. The voiced instructions can correspond to one or more of dialing a number, looking up a number in a phone book associated with a communications unit, or sending a text message and the control message result in a change in one of an operation, a parameter setting, and a database within the electronic device.

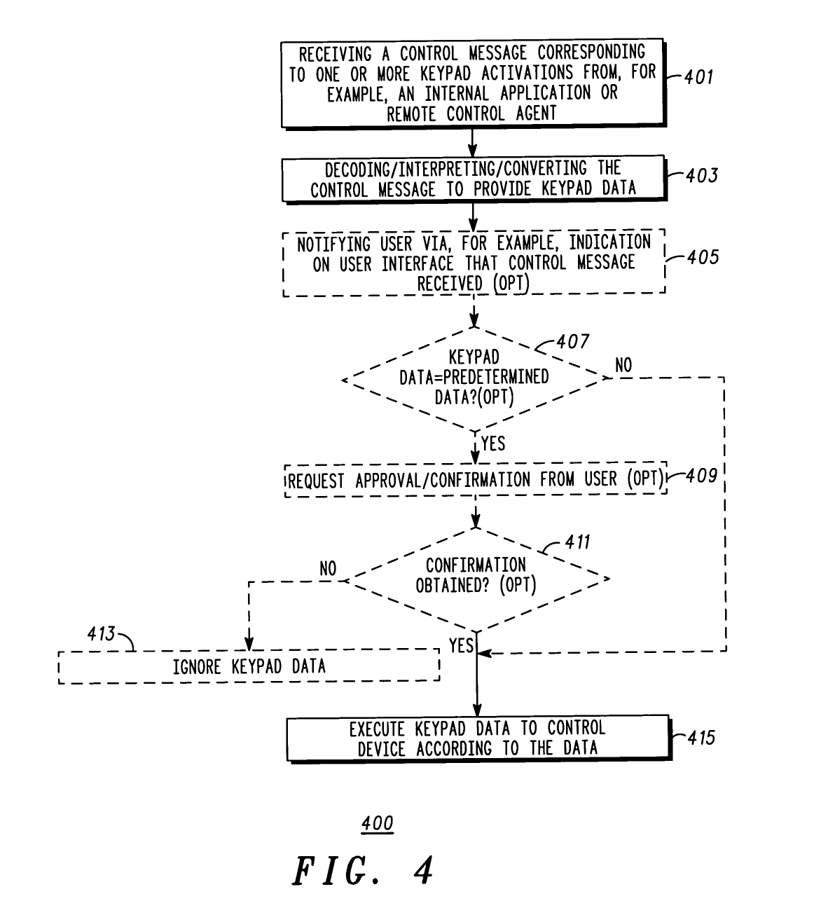

Referring to FIG. 4, a flow chart of a further method of controlling an electronic device, such as a communications unit, will be discussed and described. Some of the discussion below is a repeat of earlier material and will be presented in summary form. The device or unit 200 of FIG. 2 can advantageously perform the method 400 although various other structures would also be suitable for performing the method. The method 400, as noted above, is a method of controlling an electronic device and begins at 401 with receiving a control message that corresponds to one or more keypad activations from, for example, an internal or external associated application or remote control agent. Then 403 shows providing, responsive to the control message, keypad data corresponding to the keypad activations by decoding, interpreting, or converting the control message. As noted above with reference to FIG. 3 the control message may result from sending voiced instructions to a remote agent wherein the control message is received from the remote agent and is responsive to the sending the voiced instructions.

Then 405 shows an optional but preferred process of notifying a user of the device via, for example an indication on the user interface that the control message has been received. At 407 optionally the keypad data can be compared to a set of predetermined data and if they are equal 409 requests an approval or confirmation that the keypad data should be used from the user. Then, optional 411 determines whether the approval was obtained and if not 413 shows ignoring the keypad data. Note that obtaining the confirmation depends on the particulars of the keypad data. If the approval has been obtained at 411, the process at 415 shows controlling, according to the keypad data, the electronic device by executing the keypad data. Note that 405 is optional and the combination of 407-413 is separately optional. If the optional processes are not included, the method goes from 403 directly to 415. If the process at 405 is included by not those at 407-413 the flow goes from 405 to 415. Also if 407-413 is included and the keypad data is not equivalent to the predetermined data the “no” branch from 407 goes to 415.

The apparatus, processes, and systems discussed above and the inventive principles thereof are intended to and can alleviate problems caused by present control approaches as well as offer a novel and advantageous methodology for providing assistance to a user of an electronic device or communications unit. Using these principles of sending voiced instructions, converting these instructions and receiving corresponding control commands specific to a device or unit for execution by that device or unit will facilitate a cost effective, efficient, and friendly means for assisting a user with tasks that are otherwise burdensome and hence often avoided, thus contributing to user satisfaction.

Furthermore the concepts and principles disclosed and discussed for controlling a device or unit by sending keypad data corresponding to keypad activations will provide a secure means of controlling the device or unit since a controlling agent such as an internal application or remote agent or application will not be able to do anything that a user of the device could not do with the keyboard. It is expected that one of ordinary skill given the above described principles, concepts and examples will be able to implement other alternative procedures that are communications device dependent and that will also offer additional quick and efficient procedures for controlling or assisting a device or unit. It is anticipated that the claims below cover many such other examples.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of controlling an electronic device, the method comprising:
receiving a control message that corresponds to a keypad activation;
providing, responsive to the control message, keypad data corresponding to the keypad activation; and
controlling the electronic device according to the keypad data.

2. The method of claim 1 wherein the receiving the control message further comprises receiving the control message from one of an application internal to the electronic device and a remote control agent.

3. The method of claim 1 wherein the providing keypad data further comprises converting the control message to the keypad data.

4. The method of claim 1 wherein the controlling the electronic device according to the keypad data further comprises obtaining a confirmation from a user of the electronic device prior to the controlling according to the keypad data.

5. The method of claim 4 wherein the obtaining the confirmation depends on the keypad data.

6. The method of claim 1 further comprising sending voiced instructions to a remote agent and wherein the control message is received from the remote agent and is responsive to the sending the voiced instructions.

7. The method of claim 6 wherein the control message corresponds to one or more keypad activations that correspond to a conversion of the voiced instructions by the remote agent.

8. The method of claim 7 wherein the voiced instructions is a request to modify contents of a memory of the electronic device and the control message further corresponds to keypad activations for modifying the contents according to the voiced instructions.

9. The method of claim 7 wherein the electronic device is a communications unit and the voiced instructions corresponds to one of dialing a number, looking up a number in a phone book associated with the communications unit, and sending a text message.

10. The method of claim 7 wherein the control message results in a change in one of an operation, a parameter setting, and a database within the electronic device.

11. A communications unit arranged and constructed for utilizing remote assistance, the communications unit comprising:
a transmitter to send a message corresponding to voiced instructions to a remote agent;
a receiver to receive, responsive to the message, a control message from the remote agent; and
a controller, coupled to the transmitter and the receiver, to decode the control message to obtain and execute control commands that correspond to a conversion of the voiced instructions by the remote agent.

12. The communications unit of claim 11 further comprising a user interface, coupled to the controller, for providing the voiced instructions.

13. The communications unit of claim 12 wherein the user interface further comprises a push to talk button to initiate sending the message.

14. The communications unit of claim 12 wherein the receiver further receives a confirmation message from the remote agent when the message has been received and the controller provides an indication of the confirmation message on the user interface.

15. The communications unit of claim 12 wherein the controller provides an indication on the user interface when the control message has been received.

16. The communications unit of claim 12 wherein the controller, prior to executing a portion of the control commands, requests an approval from a user via the user interface.

17. The communications unit of claim 11 wherein the transmitter sends the message over a voice over Internet protocol packet data connection and the receiver receives the control message over a packet data connection.

18. The communications unit of claim 11 wherein the control commands when executed by the controller result in a change in one of an operation, a parameter setting, and a database within the communications unit.

19. The communications unit of claim 18 wherein the control commands when executed by the controller further result in one of dialing a number, looking up a number in a phone book associated with the communications unit, and sending a text message.

20. The communications unit of claim 11 wherein the control message corresponds to a keypad activation and the controller decodes the control message to obtain keypad data corresponding to the keypad activation and executes commands according to the keypad data.

21. The communications unit of claim 20 wherein the voiced instructions is one of a request for modifying contents of a memory, dialing a number, looking up a number, and sending a text message, and the control message further corresponds to keypad activations for the one of modifying contents of the memory, dialing the number, looking up the number, and sending the text message according to the voiced instructions.

22. A system for controlling a communications unit, the system comprising:
a controller further comprising a processor and a memory;
the processor for interpreting a control message that corresponds to one or more keypad activations to provide keypad data; and
a keypad buffer for storing the keypad data;
wherein the processor executes software instructions stored in the memory to control the communication unit according to the keypad data.

23. The system of claim 22 wherein the control message is obtained from one of an application internal to the communications unit and a remote control agent.

24. The system of claim 22 wherein the processor executes the software instructions to control the communications unit according to the keypad data after requesting and obtaining a confirmation from a user.

25. The system of claim 24 wherein the requesting the confirmation from the user depends on the keypad data.

26. The system of claim 22 wherein the processor executing the software instructions results in a change in one of an operation, a parameter setting, and a database within the communications unit.

27. The system of claim 26 wherein the processor executing the software instructions results in one of dialing a number, looking up a number in a phone book associated with the communications unit, and sending a text message.

28. A system arranged, constructed, and disposed within a communications unit for utilizing remote assistance to control the communication unit, the system comprising:
a user interface for providing a voiced signal corresponding to voiced instructions; and
a controller, coupled to the user interface and further comprising:
a modem for generating a message corresponding to the voiced signal, the message intended for a remote agent and for demodulating a control message provided, responsive to the message, by the remote agent; and
a processor, coupled to the modem, to decode the control message to obtain and execute control commands that correspond to a conversion of the voiced instructions by the remote agent.

29. The system of claim 28 wherein the user interface further comprises a push to talk button to initiate generating the message.

30. The system of claim 28 wherein the modem demodulates a confirmation message from the remote agent when the message has been received and the processor provides an indication of the confirmation message on the user interface.

31. The system of claim 28 wherein the processor provides an indication on the user interface when the control message has been demodulated.

32. The system of claim 28 wherein the controller, prior to executing a portion of the control commands, requests an approval from a user via the user interface.

33. The system of claim 28 wherein the control commands when executed by the processor result in a change in one of an operation, a parameter setting, and a database within the communications unit.

34. The system of claim 33 wherein the control commands when executed by the processor further result in one of dialing a number, looking up a number in a phone book associated with the communications unit, and sending a text message.

35. The communications unit of claim 28 wherein the control message corresponds to a keypad activation and the processor decodes the control message to obtain keypad data corresponding to the keypad activation and executes commands according to the keypad data.
